(19) United States
(12) Patent Application Publication
(10) Pub. No.: US 2020/0116581 A1
(43) Pub. Date: Apr. 16, 2020

(54) GRAVITY COMPENSATED PRESSURE SENSOR SYSTEM AND METHOD FOR CALIBRATING A PRESSURE SENSOR

(71) Applicant: Javid Majid, Houston, TX (US)

(72) Inventor: Javid Majid, Houston, TX (US)

(73) Assignee: Baker Hughes, a GE company, LLC, Houston, TX (US)

(21) Appl. No.: 16/158,599

(22) Filed: Oct. 12, 2018

(51) Int. Cl. G01L 19/02; G01L 27/00

(52) U.S. Cl. CPC G01L 19/02; G01L 2019/0053; G01L 27/005

(57) ABSTRACT

A sensor system for a sub-surface system is disclosed, comprising a pressure sensor positioned in a first orientation; a gravity sensor arranged proximate to the pressure sensor, the gravity sensor detecting gravitational force on the pressure sensor relative to the first orientation; and a data acquisition system operatively connected to each of the pressure sensor and the gravity sensor, the data acquisition system determining a gravity compensated pressure value detected by the pressure sensor corrected for gravitational force on the pressure sensor relative to the first orientation.

### BACKGROUND

In the resource exploration and recovery industry, pressure gauges are employed in a wide variety of uses. Pressure gauges may be used to determine flow, tool activation, seal activation as well as in many other applications. In order to improve accuracy, pressure gauges are typically calibrated prior to use. During calibration, a gauge factor is determined. The gauge factor is used by a data acquisition system to adjust sensed values to reflect actual parameters.

Gravitational forces have an impact on gauge accuracy. During calibration, the sensor is typically held in a particular orientation and a gauge or calibration factor is determined. The sensor thus works best in the same orientation in which it was calibrated. In situations where the sensor is used in a different orientation, gravity may have an effect on the sensor different than it had during calibration. The effect of gravity in any orientation different than the calibration orientation may have a negative effect on accuracy of the information gleaned from the sensor. Accordingly, industry would be receptive of a system for accounting for gravitational biases in sensor use and calibration.

### SUMMARY

Disclosed is a sensor system for a sub-surface system including a pressure sensor positioned in a first orientation, and a gravity sensor arranged proximate to the pressure sensor. The gravity sensor detects gravitational force on the pressure sensor relative to the first orientation. A data acquisition system is operatively connected to each of the pressure sensor and the gravity sensor. The data acquisition system determines a gravity compensated pressure value detected by the pressure sensor corrected for gravitational force on the pressure sensor relative to the first orientation.

Also disclosed is a sensor system including a pressure sensor positioned in a first orientation, and a data acquisition system operatively connected to the pressure sensor. The data acquisition system determines a gravity compensated pressure value detected by the pressure sensor corrected for gravitational force on the pressure sensor relative to the first orientation.

Further disclosed is a method of calibrating a pressure sensor including positioning the pressure sensor in a calibration system in a first orientation, positioning a gravity sensor in the calibration system, sensing a gravitational force on the pressure sensor relative to the first orientation, determining a calibration coefficient of the pressure sensor, and determining a gravity based correction factor based on a the gravitational force on the pressure sensor relative to the first orientation.

### BRIEF DESCRIPTION OF THE DRAWINGS

The following descriptions should not be considered limiting in any way. With reference to the accompanying drawings, like elements are numbered alike:

FIG. 1 depicts a resource exploration and recovery system including a gravity compensated sensor system, in accordance with an aspect of an exemplary embodiment;

FIG. 2 is a block diagram depicting the gravity compensated sensor system of FIG. 1, in accordance with an aspect of an exemplary embodiment;

FIG. 3 is a block diagram depicting a gravity compensated sensor system, in accordance with another aspect of an exemplary embodiment;

FIG. 4 is a block diagram depicting a gravity compensated sensor system, in accordance with yet another aspect of an exemplary embodiment; and

FIG. 5 depicts a calibration system for a gravity compensated sensor system, in accordance with an aspect of an exemplary embodiment

### DETAILED DESCRIPTION

A detailed description of one or more embodiments of the disclosed apparatus and method are presented herein by way of exemplification and not limitation with reference to the Figures.

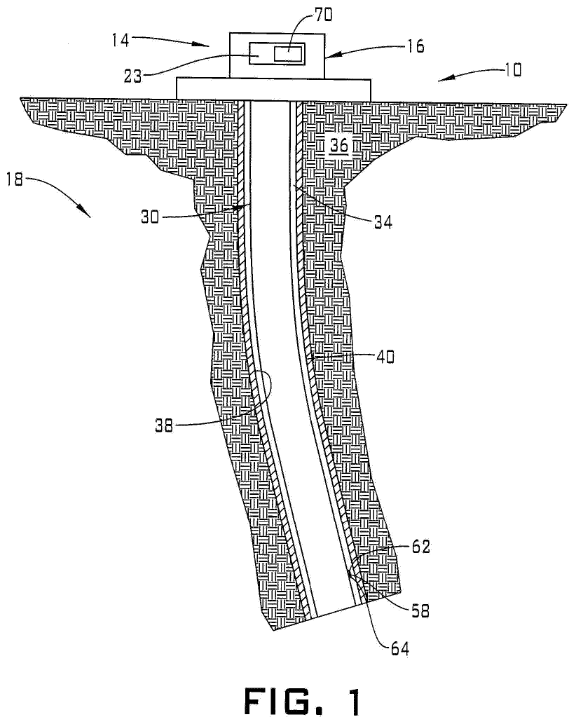

A resource exploration and recovery system, in accordance with an exemplary embodiment, is indicated generally at 10, in FIG. 1. Resource exploration and recovery system 10 should be understood to include well drilling operations, completions, resource extraction and recovery, CO₂ sequestration, and the like. Resource exploration and recovery system 10 may include a first system 14 which, in some environments, may take the form of a surface system 16 operatively and fluidically connected to a second system 18 which, in some environments, may take the form of a subsurface system.

First system 14 may include a control system 23 that may provide power to, monitor, communicate with, and/or activate one or more downhole operations as will be discussed herein. Surface system 16 may include additional systems such as pumps, fluid storage systems, cranes and the like (not shown). Second system 18 may include a tubular string 30 that extends into a wellbore 34 formed in a formation 36. Tubular string 30 may be formed by a series of interconnected discrete tubulars or by a single tubular that could take the form of coiled tubing. Wellbore 34 includes an annular wall 38 which may be defined by a surface of formation 36, or, in the embodiment shown, by a casing tubular 40. It should be understood that wellbore 34 may also include an open hole configuration.

A gravity compensated sensor system 58 is mounted to an outer surface (not separately labeled) of tubular string 30 or the annular wall 38. Gravity compensated sensor system 58 is arranged to detect pressures at a selected point along tubular string 30 or annular wall 38. It should be understood that while shown on an outer surface, gravity compensated sensor system 58 may be arranged internally to tubular string 30.

Referring to FIG. 2, gravity compensated sensor system 58 includes a pressure sensor 62 and a gravity sensor 64 operatively connected to a data acquisition system 70. Gravity sensor 64 is arranged proximate to pressure sensor 62. Data acquisition system 70 may form part of control system 23 and be arranged at first system 14. Pressure sensor 62 may take the form of a strain gauge 80. Strain gauge 80 may take on various forms including electro-resistive strain gauges. It should be understood that pressure sensor 62 may take on other forms such as quartz based pressure sensors. Other types of pressure sensors such those based on silicon, sapphire, or the like. Pressure sensor 62 may be arranged in an isolation fluid 82 that enhances pressure sensing capabilities. Of course, it should be understood that pressure sensor 62 may also be employed without the use of an isolation fluid. Gravity sensor 64 may take the form of an accelerometer 86. Gravity sensor 64 may also be arranged in an isolation fluid 88.

In an exemplary embodiment, pressure sensor 62 may be arranged in a first orientation 92 that may follow an angle of tubular string 30. That is, gravity sensor 64 may be at a non-perpendicular angle relative to a surface (not separately labeled) of formation 36. Gravitational forces may impact accuracy of pressure sensor 62. In order to compensate for any effect gravity may have on pressure sensor 62, data acquisition system 70 determines a correction factor based on inputs received from gravity sensor 64.

In this manner, data acquisition system 70 may determine a gravity compensated pressure value to establish more accurate pressure readings from pressure sensor 62 regardless of orientation. That is, pressure readings are adjusted or corrected for gravitational force on pressure sensor 62. The use of gravity sensor 64 increases pressure sensing accuracy by attaining a better resolved pressure reading. The use of gravity sensor 64 may also achieve greater resolution of acquired pressure readings.

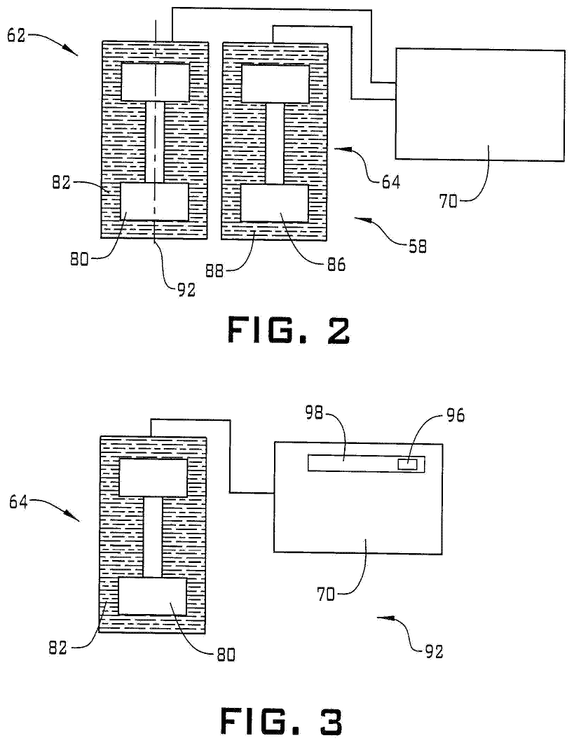

Reference will now follow to FIG. 3, wherein like reference numbers refer to corresponding parts in the respective views, in describing a gravity compensated sensor system 58 in accordance with another exemplary aspect. In accordance with an exemplary aspect, pressure sensor 62 may be calibrated prior to deployment in a manner similar to that described herein. In addition to determining a gauge factor for pressure gauge 62, calibration also determines a gravity based calibration factor 96 which may be stored in a non-volatile memory 98 of data acquisition system 70. In this manner, data acquisition system 70 may determine gravity compensate pressure values based on signals received from pressure sensor 62.

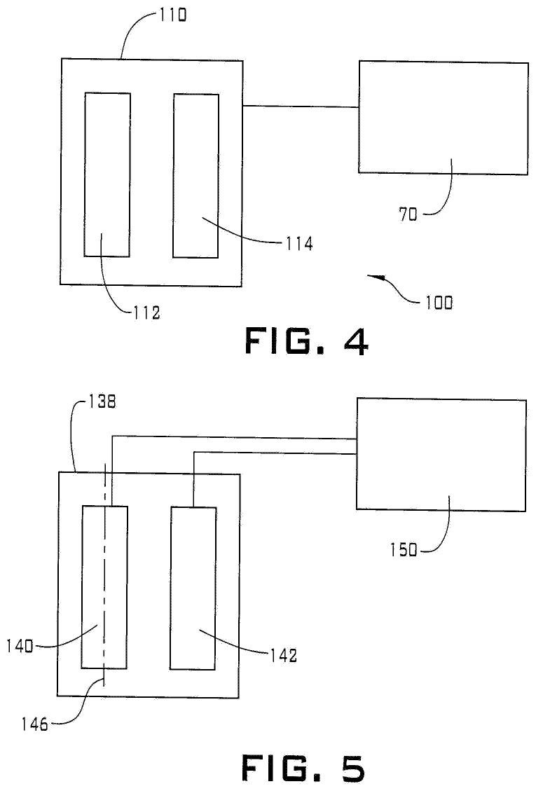

Reference will now follow to FIG. 4, wherein like reference numbers refer to corresponding parts in the respective views, in describing a gravity compensated sensor system 100 in accordance with another exemplary aspect. In accordance with an exemplary aspect, gravity compensated sensor system 100 includes a sensor package 110. Sensor package 110 defines a common package that houses both a pressure sensor 112 and a gravity sensor 114. Pressure sensor 112 and gravity sensor 114 are operatively connected to data acquisition system 70.

In a manner similar to that described herein, sensor package 110 may be arranged in a first orientation (not separately labeled) that may follow an angle of tubular string 30. That is, sensor package 110 may be arranged such that pressure sensor 112 may be at a non-perpendicular angle relative to a surface (not separately labeled) of formation 36. Gravitational forces may impact accuracy of pressure sensor 112. In order to compensate for any effect gravity may have on pressure sensor 112, data acquisition system 70 determines a correction factor based on inputs received from gravity sensor 114. In this manner, data acquisition system 70 may determine more accurate pressure readings from pressure sensor 112 regardless of orientation.

Reference will now follow to FIG. 5 in describing a calibration system 138 in accordance with an exemplary embodiment. Calibration system 138 receives a pressure sensor 140 and a gravity sensor 142. Pressure sensor 140 is arranged at a first orientation 146. Pressure sensor 140 and gravity sensor 142 are coupled to a calibration unit 150. Calibration unit 150 determines calibration coefficient or gauge factor for pressure sensor 140. Calibration unit 150 also determines a gravity based correction factor for pressure sensor 140. The gravity based correction factor may be employed by a data acquisition system to adjust for gravitational effects on a pressure sensor installed with a sub-surface system. In this manner, when in use, gravity compensated pressure readings may be determined to enhance downhole operations.

Set forth below are some embodiments of the foregoing disclosure:

### Embodiment 1

A sensor system for a sub-surface system comprising: a pressure sensor positioned in a first orientation; a gravity sensor arranged proximate to the pressure sensor, the gravity sensor detecting gravitational force on the pressure sensor relative to the first orientation; and a data acquisition system operatively connected to each of the pressure sensor and the gravity sensor, the data acquisition system determining a gravity compensated pressure value detected by the pressure sensor corrected for gravitational force on the pressure sensor relative to the first orientation.

### Embodiment 2

The sensor system according to any prior embodiment, wherein the pressure sensor is surrounded by an isolation fluid.

### Embodiment 3

The sensor system according to any prior embodiment, wherein the pressure sensor comprises a strain gauge.

### Embodiment 4

The sensor system according to any prior embodiment, wherein the pressure sensor comprises a quartz based sensor.

### Embodiment 5

The sensor system according to any prior embodiment, wherein the pressure sensor and the gravity sensor are arranged in a common package.

### Embodiment 6

The sensor system according to any prior embodiment, wherein each of the pressure sensor and the gravity sensor are mounted to a tubular extending into a sub-surface formation.

### Embodiment 7

The sensor system according to any prior embodiment, wherein the gravity sensor comprises an accelerometer.

### Embodiment 8

A sensor system comprising: a pressure sensor positioned in a first orientation; and a data acquisition system operatively connected to the pressure sensor, the data acquisition system determining a gravity compensated pressure value detected by the pressure sensor corrected for gravitational force on the pressure sensor relative to the first orientation.

### Embodiment 9

The sensor system according to any prior embodiment, wherein the data acquisition system includes a non-volatile memory having stored thereon a gravity compensated pressure value for the pressure sensor.

### Embodiment 10

The sensor system according to any prior embodiment, wherein the pressure sensor is surrounded by an isolation fluid.

### Embodiment 11

The sensor system according to any prior embodiment, wherein the pressure sensor comprises a strain gauge.

### Embodiment 12

The sensor system according to any prior embodiment, wherein the pressure sensor comprises a quartz based sensor.

### Embodiment 13

The sensor system according to any prior embodiment, wherein the pressure sensor is mounted to a tubular extending into a sub-surface formation.

### Embodiment 14

A method of calibrating a pressure sensor comprising: positioning the pressure sensor in a calibration system in a first orientation; positioning a gravity sensor in the calibration system; sensing a gravitational force on the pressure sensor relative to the first orientation; determining a calibration coefficient of the pressure sensor; and determining a gravity based correction factor based on a the gravitational force on the pressure sensor relative to the first orientation.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A sensor system for a sub-surface system comprising:
a pressure sensor positioned in a first orientation;
a gravity sensor arranged proximate to the pressure sensor, the gravity sensor detecting gravitational force on the pressure sensor relative to the first orientation; and
a data acquisition system operatively connected to each of the pressure sensor and the gravity sensor, the data acquisition system determining a gravity compensated pressure value detected by the pressure sensor corrected for gravitational force on the pressure sensor relative to the first orientation.

2. The sensor system according to claim 1, wherein the pressure sensor is surrounded by an isolation fluid.

3. The sensor system according to claim 1, wherein the pressure sensor comprises a strain gauge.

4. The sensor system according to claim 1, wherein the pressure sensor comprises a quartz based sensor.

5. The sensor system according to claim 1, wherein the pressure sensor and the gravity sensor are arranged in a common package.

6. The sensor system according to claim 1, wherein each of the pressure sensor and the gravity sensor are mounted to a tubular extending into a sub-surface formation.

7. The sensor system according to claim 1, wherein the gravity sensor comprises an accelerometer.

8. A sensor system comprising:
a pressure sensor positioned in a first orientation; and
a data acquisition system operatively connected to the pressure sensor, the data acquisition system determining a gravity compensated pressure value detected by the pressure sensor corrected for gravitational force on the pressure sensor relative to the first orientation.

9. The sensor system according to claim 8, wherein the data acquisition system includes a non-volatile memory having stored thereon a gravity compensated pressure value for the pressure sensor.

10. The sensor system according to claim 8, wherein the pressure sensor is surrounded by an isolation fluid.

11. The sensor system according to claim 8, wherein the pressure sensor comprises a strain gauge.

12. The sensor system according to claim 8, wherein the pressure sensor comprises a quartz based sensor.

13. The sensor system according to claim 8, wherein the pressure sensor is mounted to a tubular extending into a sub-surface formation.

14. A method of calibrating a pressure sensor comprising:
positioning the pressure sensor in a calibration system in a first orientation;
positioning a gravity sensor in the calibration system;
sensing a gravitational force on the pressure sensor relative to the first orientation;
determining a calibration coefficient of the pressure sensor; and
determining a gravity based correction factor based on a the gravitational force on the pressure sensor relative to the first orientation.
